(19) United States
(12) Patent Application Publication
(10) Pub. No.: US 2022/0174994 A1
(43) Pub. Date: Jun. 9, 2022

(54) AN IMPROVED COOKED PRODUCT, DOUGH OR BATTER AND DOUGH OR BATTER MAKING PROCESS

(71) Applicant: SAKARI PTY LTD, Kambah (AU)

(72) Inventor: Tommi RUMMUKAINEN, Kambah (AU)

(21) Appl. No.: 17/598,574

(22) PCT Filed: Mar. 4, 2020
(86) PCT No.: PCT/AU2020/050199

§ 371 Date: Sep. 27, 2021

(30) Foreign Application Priority Data
Mar. 28, 2019 (AU) 2019901046

(51) Int. Cl. A23L 5/42; A21D 2/36; A21D 13/02; A23L 7/191; A21D 13/47

(52) U.S. Cl. CPC A23L 5/42; A21D 2/36; A23V 2002/00; A23L 7/191; A21D 13/47; A21D 13/02

(57) ABSTRACT

The present invention provides a method of making a dough or batter and grain product, the method including the making of a dough or batter and including the step of soaking one or more whole grains in a dye of colour and or multiple collections of grains in respective dyes of different colours, until the whole grains absorb the dye or respective ones of the dyes. Also provided is a dough or batter and grain product and a cooked product, being either baked, fried or boiled.

### FIELD OF THE INVENTION

The present invention relates to cooked products and a dough or batter for such products and an improved dough or batter making process. More specifically the invention relates to a bread and or cooked product with coloured wholegrains and or coloured puffed wholegrains, so that the bread and or cooked products produced will have increased aesthetic appeal and thus provide nutritional value.

### BACKGROUND OF THE INVENTION

Getting children to eat what is good for them can be difficult. There has been a long felt need for a means to entice children to eat baked goods such as bread, particularly those with wholegrains in them.

Wholegrains are an important part of a growing child's diet, providing them with vital nutrients to get through the day. Wholegrains are a good source of fibre, iron, carbohydrates and other vitamins and minerals.

Wholegrain bread and or baked good products contain a dietary fibre content of up to four times greater than white bread and refined white flour products and also contain more vitamins and protein compared to white bread and refined white flour products. However health conscious parents often find it difficult to include enough wholegrain bread and or baked good products as the common preference with children tends to be white bread and or refined white flour products.

Traditional and conventional breads and or cooked good products that include wholegrains are considered an excellent source of wholegrains, yet can be very unappealing to children making it harder for parents to nourish children with wholegrains that developing bodies require.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a method of making a dough or batter and grain product, the method including the making of a dough or batter and including the step of soaking one or more wholegrains and or puffed wholegrains in a dye of colour and or multiple collections of grains and or puffed wholegrains in respective dyes of different colours, until the wholegrains and or puffed wholegrains absorb the dye or respective ones of the dyes.

The wholegrains and or puffed wholegrains can be dried before being added to the dough or batter.

The grains and or puffed grains can be agitated while drying to prevent the grains from clumping, before being added to the dough or batter.

There are grains and or puffed grains of more than one colour, and these can be mixed together, according to a desired and or predetermined mixture proportions, before being added to the dough or batter.

The dough or batter can be made from any appropriate flour, and grains and or puffed grains as described above can be added thereto, by any appropriate processing step.

The dough or batter can be made from a flour which when cooked will provide a desired contrast or background for the colour or colours of dyed grains and or puffed grains mixed in with the dough.

The grains and or puffed grains can be added to the dough by a kneading process.

When the product is a dough and grain and or puffed grain product, the dough can be allowed to proof or prove before cooking.

When the product is a dough and grain and or puffed grain product, the dough can be punched prior to cooking.

The dough or batter and grain and or puffed grain product can then be cooked.

The present invention also provides a dough or batter and grain product produced by the method described in paragraphs [007] to [016].

The present invention also provides dough or batter and grain and or puffed grain product having grains and or puffed grains which are dyed.

The present invention also provides a cooked product, produced by cooking a dough or batter and grain and or puffed grain product as described in paragraphs [017] and [018].

The cooked product can be one of: a loaf of bread; a biscuit; a cake; a pancake; a baked confectionery; a bread roll; a muffin; a scone; a cookie; a donut; a bagel; a wrap; a pita bread; unleavened bread such as Lebanese bread etc.

The cooking process used can be baking, frying or boiling or any appropriate cooking process.

### BRIEF DESCRIPTION OF THE DRAWINGS

An embodiment or embodiments of the present invention will now be described, by way of example only, with reference to the accompanying drawings, in which:

FIG. 1 is a schematic perspective view of a loaf of bread with wholegrains in multi colours;

FIG. 2 is a schematic perspective view of a loaf of bread with whole grains in two colours;

FIG. 3 is a schematic front view of a slice from a loaf of bread with whole grains in multi colours;

FIG. 4 is a schematic front view of a slice from a loaf of bread with whole grains in two colours;

FIG. 5 is a schematic perspective view of a slice and loaf of bread with wholegrains in multi colours;

FIG. 6 is a schematic perspective view of a slice and loaf of bread with wholegrains in two colours;

FIG. 7 is a schematic perspective view of a muffin with all grains being red grains;

FIG. 8 is a schematic perspective view of a cake being with two coloured grains of green and yellow grains;

FIG. 9 is a schematic perspective view of a scone or an English muffin, having pink and red grains;

FIG. 10 is a schematic perspective view of a cookie with a heart in red grains with white grains to rest of cookie;

FIG. 11 is a schematic perspective view of a doughnut having rainbow coloured grains;

FIG. 12 is a schematic perspective view of a bagel having white, blue and red grains;

FIG. 13 is a schematic perspective view of a wrap with rainbow coloured grains

FIG. 14 is a schematic perspective view of a pide bread or flat bread or Lebanese bread with black grains in happy face details with yellow grains for rest.

FIG. 15 is a schematic perspective view of a pancake having two coloured grains therein;

FIG. 16 is a flow chart of the process to make a dough and a coloured whole grain cooked product such as a wholegrain bread;

FIG. 17 is a flow chart of the process to make a dough and a coloured whole grain cooked product such as a wholegrain cookie;

FIG. 18 is a flow chart of the process to make a dough and a coloured whole grain cooked product such as a wholegrain muffin;

FIG. 19 is a flow chart of a process to colour whole grains; and

FIG. 20 is a flow chart of a process to colour Arborio rice grains.

### DETAILED DESCRIPTION OF THE EMBODIMENT OR EMBODIMENTS

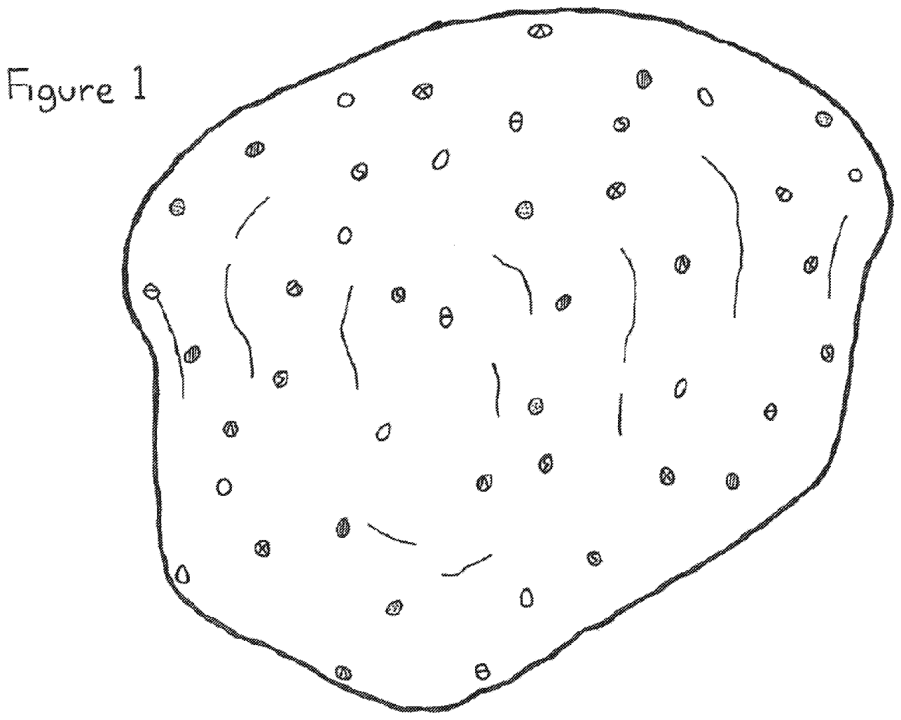

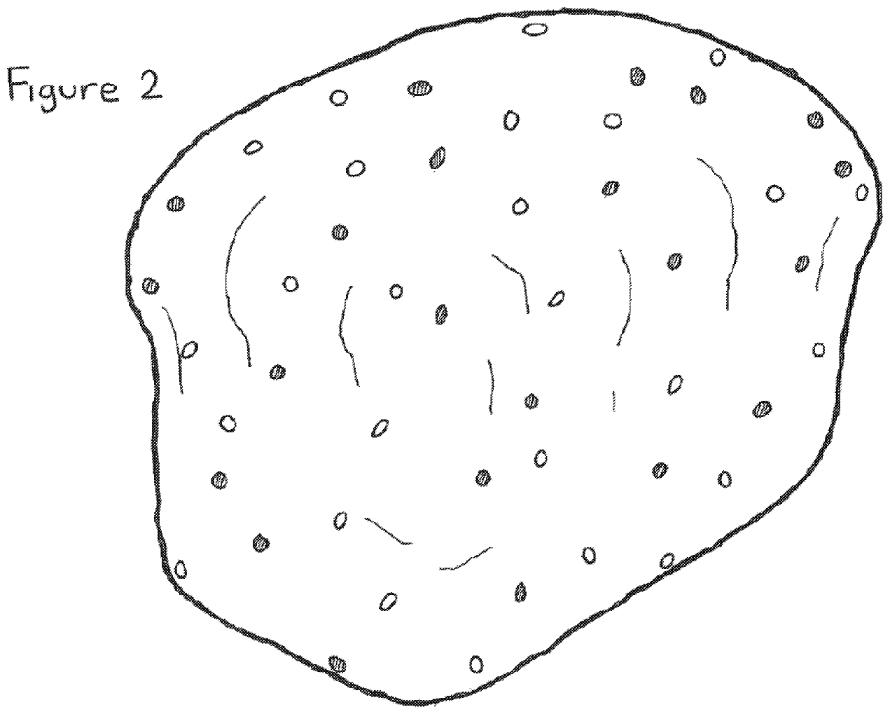

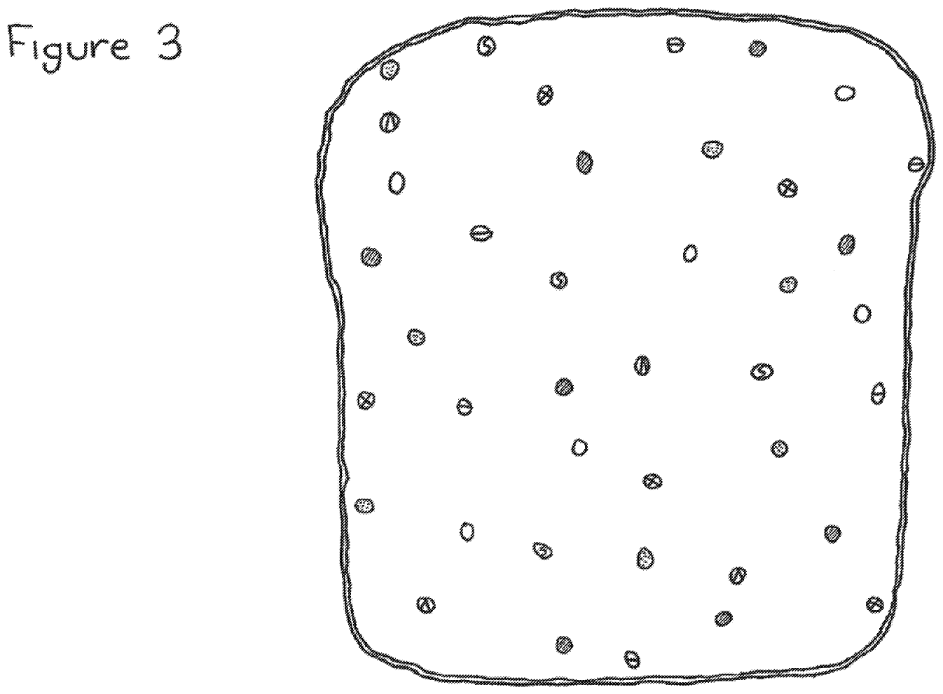

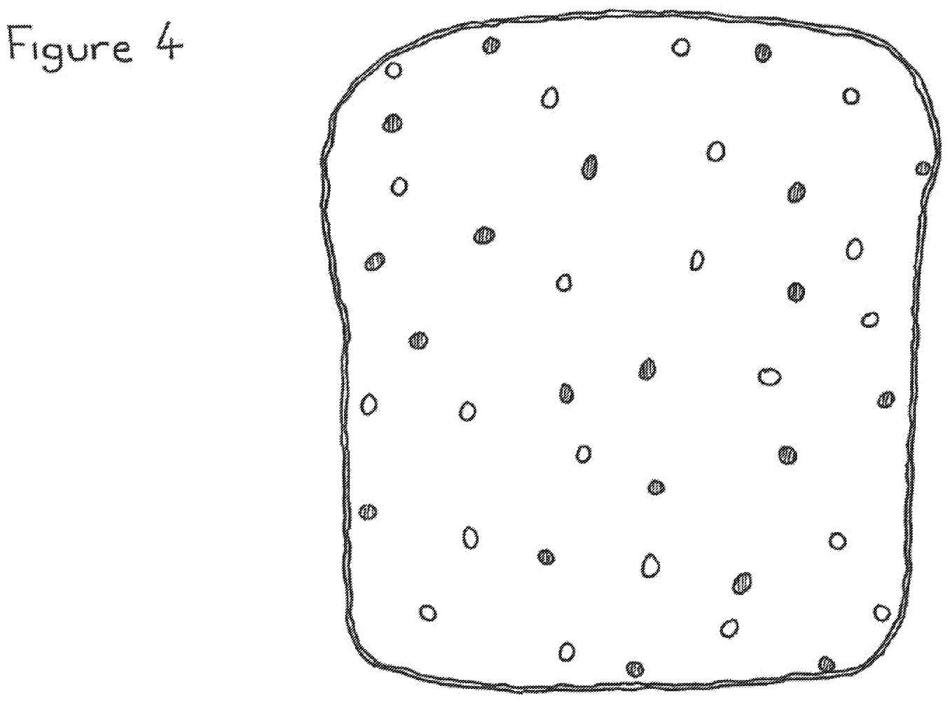

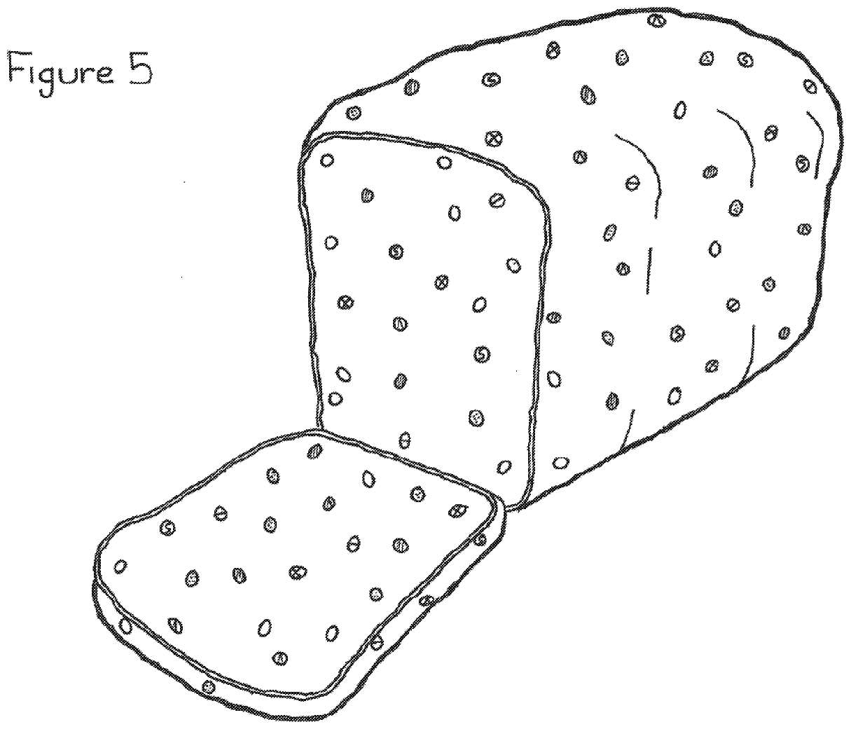

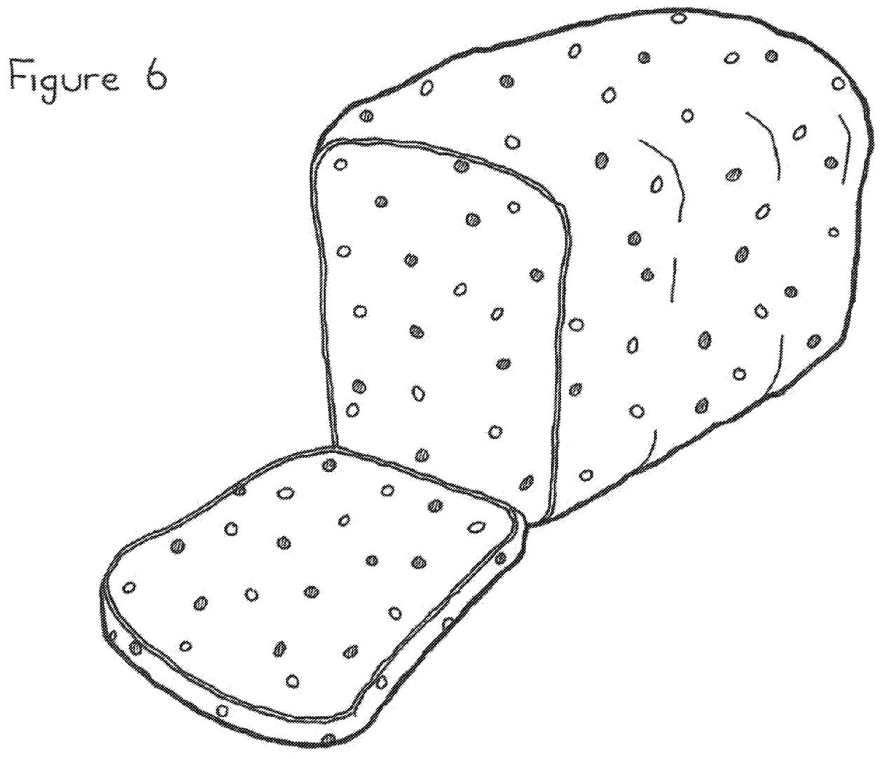

In the accompanying FIGS. 1 to 15, different colour grains and or puffed grains are represented by different markings applied to the representation of the grains. As an example, the different colours utilised may be blue, green, red, yellow, orange, purple, pink, black and brown, as in the illustrations of the products of FIGS. 1 to 6:

a blue grain and or puffed grain is represented by a grain image having a black outline and a clear or white interior;
a green grain and or puffed grain is represented by a grain image having a black outline and an “x” within;
a red grain and or puffed grain is represented by a grain image having a black outline and an “s” within;
a yellow grain and or puffed grain is be represented by a grain image having a black outline and an “-” within;
a pink grain and or puffed grain can be considered to be represented by a grain image having a black outline and a “/\” within;
a black grain and or puffed grain is represented by a grain image having a black outline and a “////” within;
a brown grain and or puffed grain is represented by a grain image having a black outline and a “\\\\” within;
a purple grain and or puffed grain is represented by a grain image having a black outline and an “vertical line” within; and
an orange grain and or puffed grain is represented by a grain image having a black outline and a “dot pattern” within.

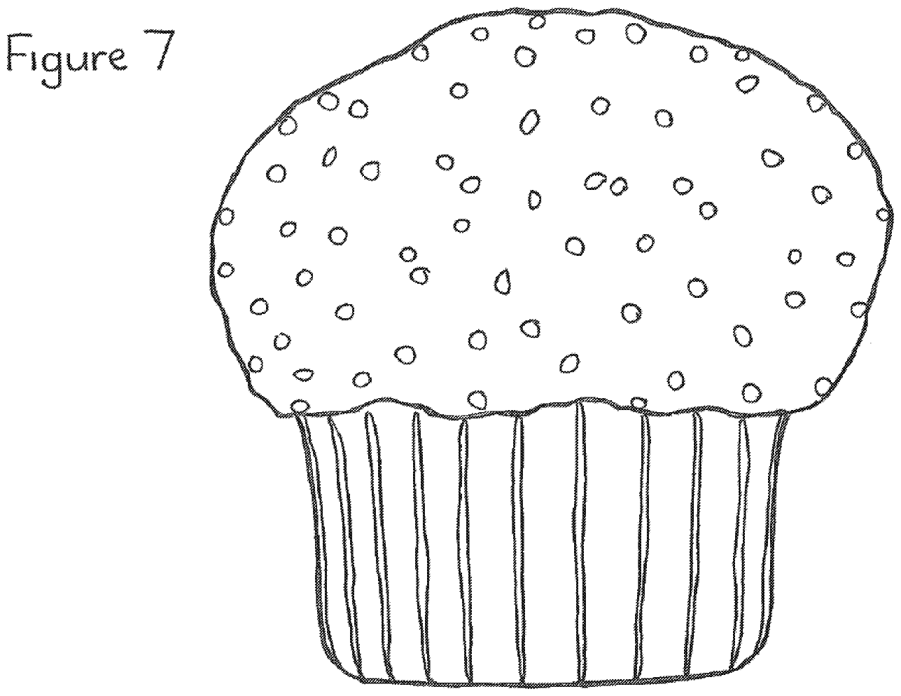

In FIG. 7 is a representation of a muffin where red grains and or puffed grains are represented by a grain images having a black outline and a clear or white interior.

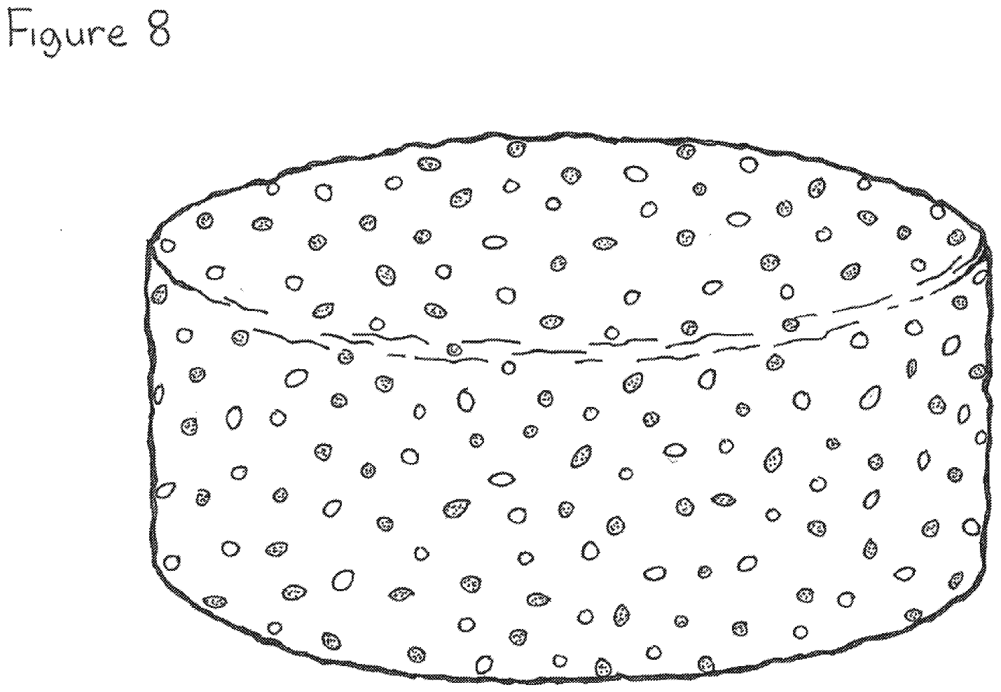

In FIG. 8 is a representation of a cake having two coloured grains and or puffed grain, where green grains and or puffed grains are represented by grain images having a black outline and a “dot pattern” within and yellow grains and or puffed grain are represented by grain images having a black outline and a clear or white interior.

FIG. 9 is a representation of a scone or an English muffin, having pink grains and or puffed grain represented by grain images having a black outline and a “/\” within, and red grains and or puffed grain represented by grain images having a black outline and a “////” within.

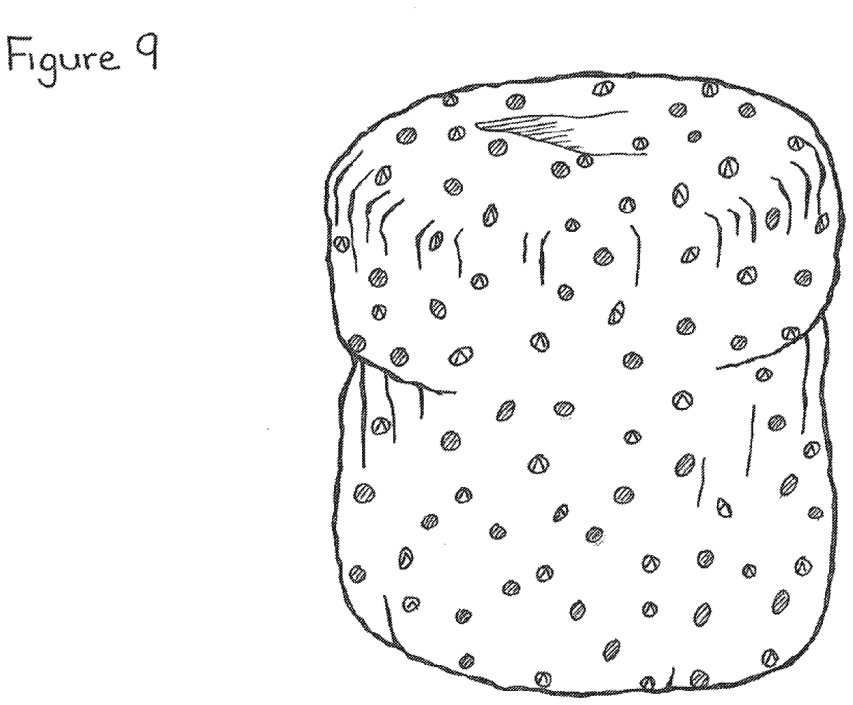

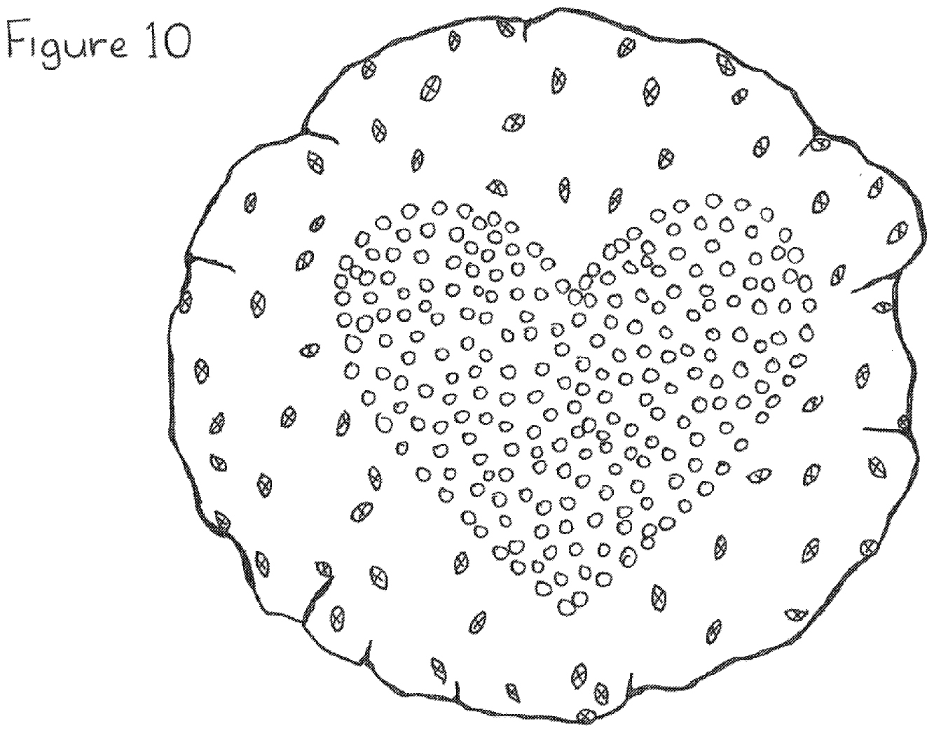

FIG. 10 is a representation of a cookie with a heart shaped feature in red grains and or puffed grain represented by grain images having a black outline and a clear or white interior, with white grains and or puffed grain being represented by grain images having a black outline and an “x” within, to rest the rest of cookie.

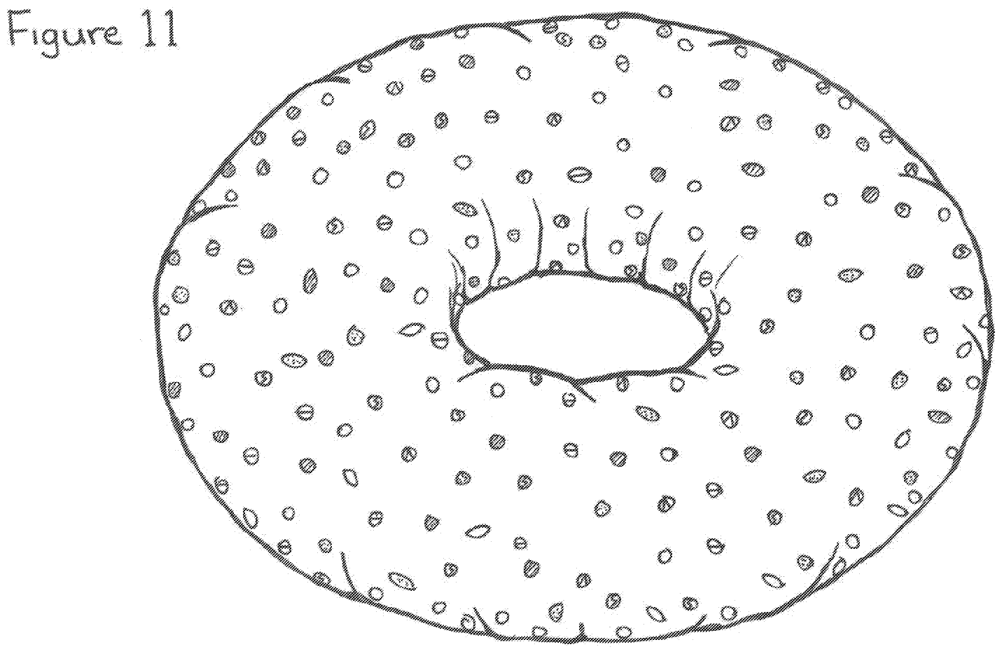

FIG. 11 is a representation of a doughnut having multiple or rainbow coloured grains and or puffed grain;

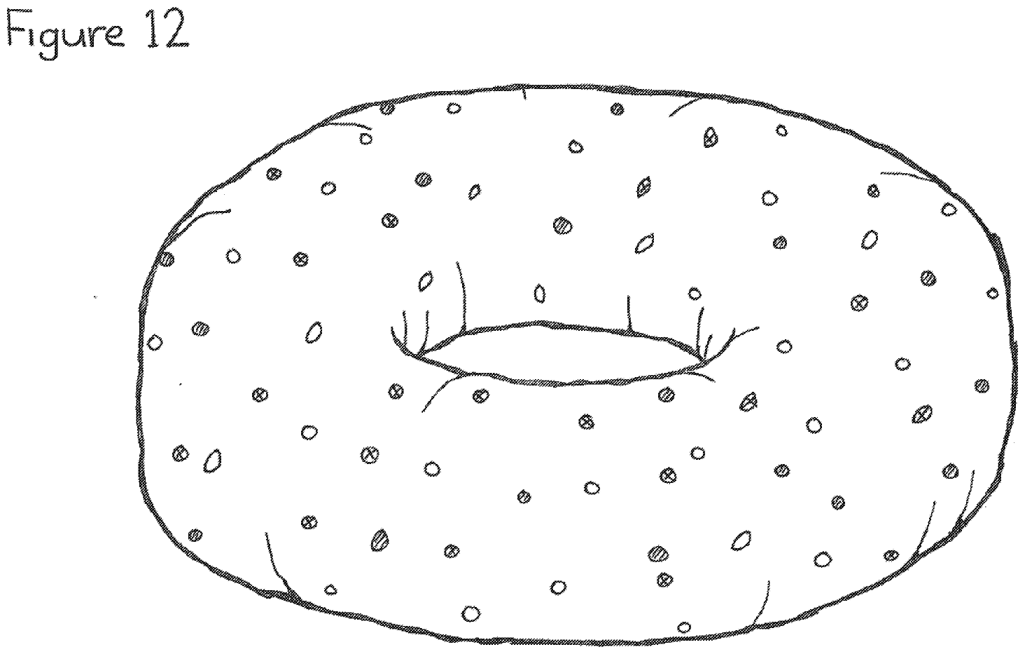

FIG. 12 is a representation of a bagel having white grains and or puffed grains represented by grain images having a black outline and an “x” within, with blue grains and or puffed grain represented by grain images having a black outline and a clear or white interior and with red grains and or puffed grains represented by grain images having a black outline and a “////” within;

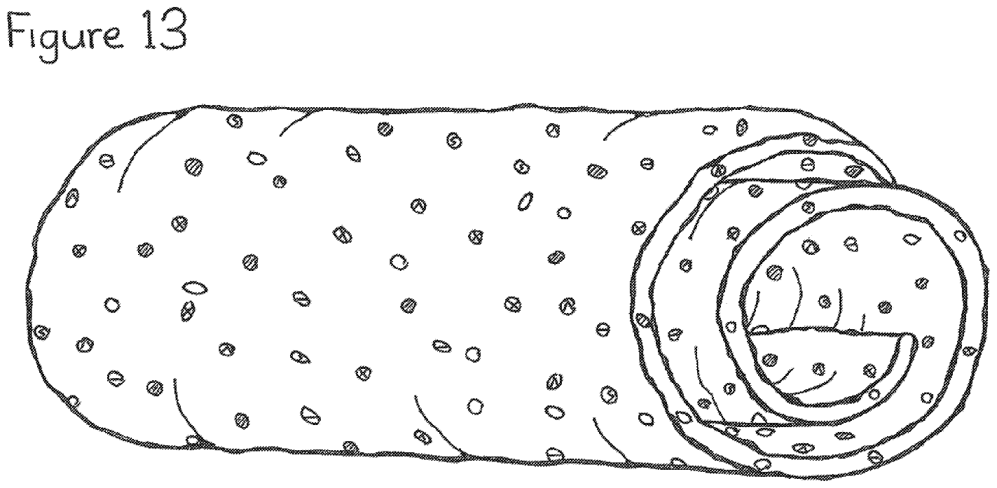

FIG. 13 is a representation of a wrap with multiple or rainbow coloured grains and or puffed grains.

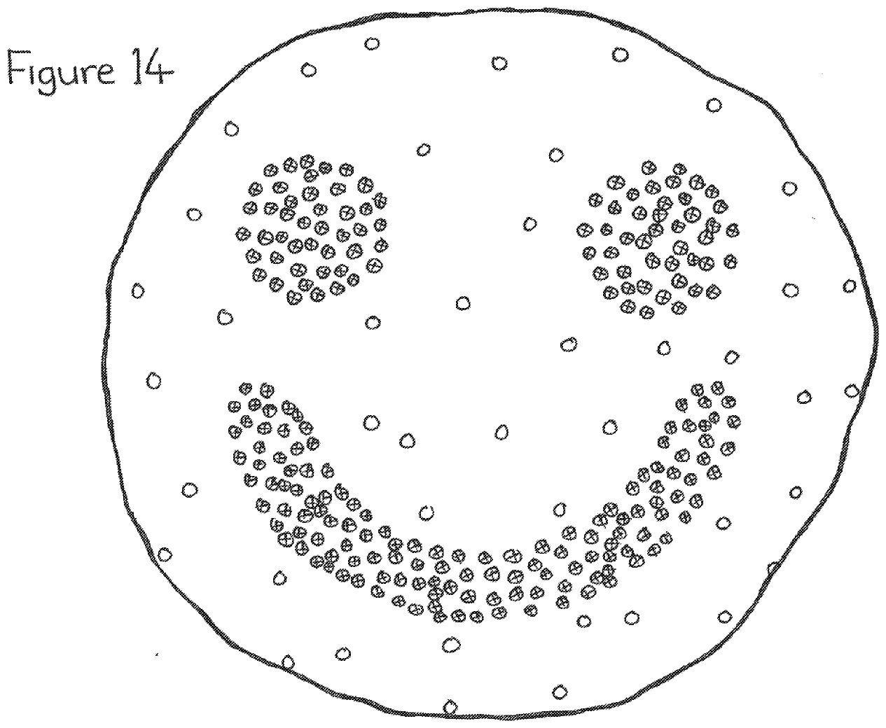

FIG. 14 is a representation of a pide bread or flat bread or Lebanese bread with black grains and or puffed grains represented by grain images having a black outline and an “x” in happy face details with yellow grains and or puffed grains for the rest represented by grain images having a black outline and a clear or white interior.

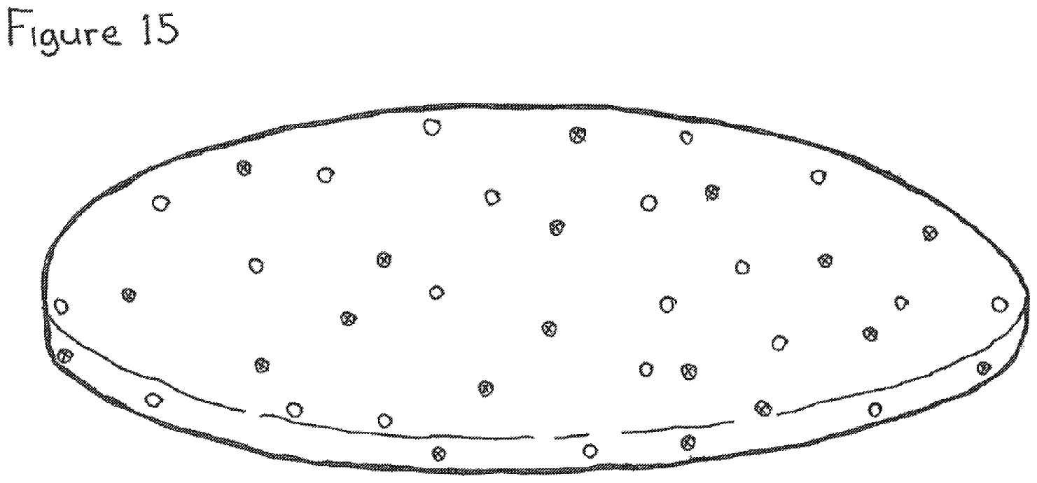

FIG. 15 is a representation of a pancake with black grains and or puffed grains represented by grain images having a black outline and an “x” with yellow grains and or puffed grains for the rest represented by grain images having a black outline and a clear or white interior

In the following text, reference is made to dough and products makeable from dough, but as will also be described, reference will be made to batter and products makeable from batter. The expressions “dough” or “batter” where appropriate, can be read to be “dough or batter”.

In a general sense the method of making a dough and grain and or puffed grain product is made up of the making of a dough into which wholegrains and or puffed wholegrains are mixed. The method additionally includes the step of soaking one or more wholegrains and or puffed wholegrains in a dye of colour and or multiple collections of grains and or puffed grains in respective dyes of different colours, until the wholegrains and or puffed wholegrains absorb the dye or respective ones of the dyes.

The wholegrains which can be used in the method include all wholegrains typically used in wholegrain bread and or cooked good products i.e. wheat, spelt, barley, rice, buckwheat, corn, oats, rye. In addition, a wide variety of grains or seeds can be used including flaxseed, quinoa, pumpkin seeds and sunflower seeds. Puffed grains, including puffed millet and puffed rice, puffed quinoa, puffed amaranth, puffed corn, puffed wheat, puffed barley, puffed spelt, and puffed buckwheat can also be used delivering a useful results. Puffed millet being a preferred wholegrain due not only to its high nutritional value but also due to its white colour and its absorptive properties makes it highly suitable for the grain colouring process.

The wholegrains are coloured with natural or synthetic pigments by soaking them in batches for each colour. The use of natural colouring increases the nutritional value of the product as the natural pigments are sourced from fruits, vegetables and berries. Some of the nutrients found in natural colouring include magnesium, calcium, potassium, iron, zinc, phosphorous and the B vitamins.

Selections of coloured grains can be used to create multicolour rainbow like effects or fewer colours used to create themed products i.e. green and yellow for Australia Day; or red and blue in a white flour bread as background for US Independence day or France's Bastille day. Thus there are grains of more than one colour, and these can be mixed together, according to a desired and or predetermined mixture proportions, before being added to the dough.

The whole grains once dyed are preferably dried before being added to the dough. The grains are also preferably agitated while drying to prevent the grains from clumping, before being added to the dough.

The dough can be made from any appropriate flour, and grains as described above can be added thereto, by any appropriate processing step. Most preferably the grains are added to the dough by a kneading process.

The dough can be made from a flour which when baked will provide a desired contrast or background for the colour or colours of dyed grains mixed in with the dough, as in the example of providing a red white and blue bread product for US Independence day or France's Bastille day.

As with all baked or cooked products the dough can be allowed to proof or prove before baking or cooking, and additionally or optionally the dough can be punched prior to baking or cooking.

Other baked or cooked products to which the invention can be applied include scones or English muffins as illustrated in FIG. 9; cookies as illustrated in FIG. 10; wraps as illustrated in FIG. 13; and pide or flat bread or Lebanese bread as illustrated in FIG. 14.

Some cooked products are made from a batter, such as muffins as illustrated in FIG. 7; cakes as illustrated in FIG. 8; or pancakes as illustrated in FIG. 15.

The dough or batter and grains can then be baked, but the invention can also be applied to products which are not typically baked but otherwise cooked such as donuts as illustrated in FIG. 11, which are fried, pancakes of FIG. 15 which are cooked on a griddle and bagels as illustrated in FIG. 12 which are boiled in their manufacture process.

While the above describes the wholegrains and puffed wholegrains being coloured using natural pigments, however the invention is not limited to natural colouring. The same appearance can be achieved using other consumable dyed wholegrains, however this will result in enhancing the aesthetic appeal for the products but may provide minimal additional nutritional benefits.

The coloured wholegrains are added to a bread and or cooked good dough or base towards the end of the kneading process long enough to distribute the multi-coloured grains throughout the dough or base. The dough or base is then allowed to rise (if required) and cooked, by baking or otherwise, as per the usual process for the particular product.

The final cooked product will appear with a rainbow-like or coloured effect featuring speckled colours of multi-grains throughout enhancing the visual appeal of the product, as illustrated in FIGS. 1 to 15 and providing increased nutritional value where natural dyes are used, because these benefits are a result of the application of dying natural pigments to the wholegrains therefore enriching the wholegrains with vitamins and minerals.

The multi coloured wholegrains and or puffed wholegrains added to the products provides increased appeal to the cooked products, particularly for children.

The coloured grains and or puffed grains can be kneaded into the dough of the bread or other product to distribute the coloured grains and or puffed grains throughout the dough prior to baking. The dough used for the bread and or baked or cooked good products can be white, wholemeal or gluten free varieties. The coloured wholegrains and or puffed wholegrains can be kneaded into the dough towards the end of the kneading process long enough to distribute the coloured grains. Excess kneading of the coloured grains into the dough or base may cause the coloured grains to blead into the dough. The dough surrounding the coloured grains is uncoloured or natural which creates contrast between the bread dough and the coloured wholegrains.

After the baking or cooking process for the products is complete, the bread and or and the cooked goods will appear with multi coloured wholegrains throughout the bread and or other cooked goods enhancing the bread and or other cooked goods aesthetically and nutritionally.

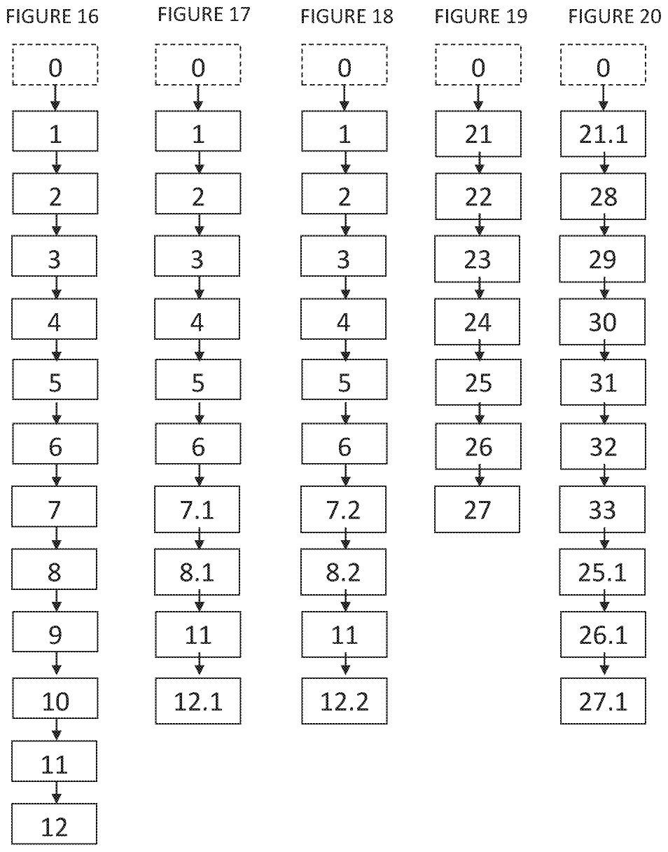

Illustrated in FIG. 16 is a flow chart representation of the method described above but more specifically related to a bread baked product. It will be readily understood that to make a biscuit product the dough making steps will require a biscuit dough to be produced with requisite increase in the amounts of sugar utilised by comparison to bread products. This will also be the case for other baked or cooked goods and or confectionery.

As illustrated in FIG. 16, the method has the following steps:

step 0-action 0: represented with a broken line in FIG. 16, as it is only utilised if puffed wholegrains are to be used. If these need to be produced rather than procured already in a puffed state, then wholegrains can be puffed by any known puffing method;
step 1-action 1: Batch wholegrains and or puffed wholegrains for colouring—one colour per batch;
step 2-action 2: Add natural colouring pigment dyes to individual batches of wholegrains and or puffed wholegrains;
step 3-action 3: Soak wholegrains and or puffed wholegrains in dye pigments as required (until wholegrains and or puffed wholegrains absorb desired colour effect);
step 4-action 4: Remove wholegrains and or puffed wholegrains from dyes, drain and allow to dry;
step 5-action 5: Mix individual grain and or puffed grain batches regularly while drying to eliminate the grains and or puffed grains clumping;
step 6-action 6: Combine selected coloured wholegrains and or puffed wholegrains together in one batch;
step 7-action 7: Prepare product dough;
step 8-action 8: Add coloured wholegrains and or puffed wholegrains to dough by kneading grains and or puffed grains throughout product;
step 9-action 9: Proof;
step 10-action 10: Punch (optional);
step 11-action 11: Bake;
step 12-action 12: Fully baked coloured wholegrain and or puffed wholegrain bread product complete

Illustrated in FIG. 17 is a flow chart representation of a method to make a cookie dough to make cookies. The method is similar to that of FIG. 16 with like items or actions being like numbered, with similar but different items or actions having the same base number but includes a decimal point. The method comprises the following steps:

step 0-action 0: represented with a broken line in FIG. 17, as it is only utilised if puffed wholegrains are to be used. If these need to be produced rather than procured already in a puffed state, then wholegrains can be puffed by any known puffing method;
step 1-action 1: Batch wholegrains and or puffed wholegrains for colouring—one colour per batch;
step 2-action 2: Add natural colouring pigment dyes to individual batches of wholegrains and or puffed wholegrains;
step 3-action 3: Soak wholegrains and or puffed wholegrains in dye pigments as required (until wholegrains and or puffed wholegrains absorb desired colour effect);
step 4-action 4: Remove wholegrains and or puffed wholegrains from dyes, drain and allow to dry;
step 5-action 5: Mix individual grain and or puffed grain batches regularly while drying to eliminate the grains and or puffed grains clumping;
step 6-action 6: Combine selected coloured wholegrains and or puffed wholegrains together in one batch;
step 7-action 7.1: Prepare cookie dough;
step 8-action 8.1: Add coloured wholegrains and or puffed wholegrains to cookie dough by kneading grains and or puffed grains throughout product;
step 9-action 11: Bake;
step 10-action 12.1: Fully baked coloured wholegrain and or puffed wholegrain cookie-product complete.

Whereas in FIG. 18 is a flow chart representation of a method to make a muffin base and to make muffins. The method is similar to that of FIGS. 16 and 17 with like items or actions being like numbered, with similar but different items or actions having the same base number but includes a decimal point. The method comprises the following steps:

step 0-action 0: represented with a broken line in FIG. 18, as it is only utilised if puffed wholegrains are to be used. If these need to be produced rather than procured already in a puffed state, then wholegrains can be puffed by any known puffing method;
step 1-action 1: Batch wholegrains and or puffed wholegrains for colouring—one colour per batch;
step 2-action 2: Add natural colouring pigment dyes to individual batches of wholegrains and or puffed wholegrains;
step 3-action 3: Soak wholegrains and or puffed grains in dye pigments as required (until wholegrains and or puffed wholegrains absorb desired colour effect);
step 4-action 4: Remove wholegrains and or puffed wholegrains from dyes, drain and allow to dry;
step 5-action 5: Mix individual grain and or puffed grain batches regularly while drying to eliminate the grains and or puffed grains clumping;
step 6-action 6: Combine selected coloured wholegrains and or puffed wholegrains together in one batch;
step 7-action 7.2: Prepare muffin base;
step 8-action 8.2: Add coloured wholegrains and or puffed wholegrains to muffin base by kneading grains and or puffed grains throughout product;
step 9-action 11: Bake;
step 10-action 12.2: Fully baked coloured wholegrain and or puffed wholegrain muffin-product complete.

Illustrated in FIG. 19 is a flowchart of wholegrain and or puffed wholegrain colouring process that can be used to produce coloured grains as described and used above. In this process, some of the colours for whole grains can include: Yellow from a Tumeric extract; Red from a Red capsicum extract; Green from a Carthamus and gardenia extract; Blue from a red cabbage extract with 1% baking soda; Purple from a red cabbage extract; Pink from Blueberry extract; and Orange from a red Capsicum extract. The method of colouring wholegrains and or puffed wholegrains comprises the following steps:

step 0-action 0: represented with a broken line in FIG. 19, as it is only utilised if puffed wholegrains are to be used. If these need to be produced rather than procured already in a puffed state, then wholegrains can be puffed by any known puffing method;
step 1-action 21: Select wholegrains and or puffed wholegrains and portion as required lx portion of wholegrains and or puffed wholegrains per colour required;
step 2-action 22: Select colouring as per product design and add colouring to bowl large enough to hold grains and or puffed grains and colouring;
step 3-action 23: Add wholegrains and or puffed wholegrains to bowl with colouring gently stir and allow 45 minutes to soak;
step 4-action 24: Wholegrains and or puffed wholegrains are removed from bowl and drained;
step 5-action 25: Spread drained wholegrains and or puffed wholegrains in a thin layer on an oven tray and place in oven on 100 degrees for 1 hour approx.;
step 6-action 26: Once dried ensure no clumps of wholegrains and or puffed wholegrains by mixing and or agitating gently;
step 7-action 27: Wholegrains and or puffed wholegrains of individual colour can now added together and is ready for use.

Illustrated in FIG. 20 is a flowchart of an Arborio rice wholegrain and or puffed Arborio rice wholegrain colouring process that can be used to produce grains and or puffed grains of colour for use in the above described products and or processes. In this process, some of the colours for Arborio rice grains and or puffed rice grains can include: Yellow from a Tumeric extract; Green from a Carthamus and gardenia extract; Blue from a Spirulina extract; Purple from a Carmine extract; Pink from a Carmine extract. The method is similar to that of FIG. 19 with like items or actions being like numbered, with similar but different items or actions having the same base number but includes a decimal point. The method of colouring wholegrains comprises the following steps:

step 0-action 0: represented with a broken line in FIG. 20, as it is only utilised if puffed wholegrains are to be used. If these need to be produced rather than procured already in a puffed state, then wholegrains can be puffed by any known puffing method;
step 1-action 21.1: Select Arborio rice wholegrains and or puffed wholegrains and portion as required 1× portion of wholegrains and or puffed wholegrains per colour required;
step 2-action 28: Rinse and drain arborio rice whole grains and or puffed wholegrains;
step 3-action 29: add water and colouring to saucepan large enough to boil both the grains and or puffed grains and colouring;
step 4-action 30: Bring water with colouring to boil;
step 5-action 31: Add arborio rice wholegrains and or puffed wholegrains to saucepan;
step 6-action 32: Partially cook arborio rice wholegrains and or puffed wholegrains for 5 to 10 minutes to cause the rice wholegrains and or puffed wholegrains to absorb the coloured water;
step 7-action 33: Rinse cooked rice wholegrains and or puffed wholegrains in cool water;
step 8-action 25.1: Spread drained arborio rice wholegrains and or puffed wholegrains in a thin layer on an oven try and place in oven on 100 degrees for 3 hours approx.;
step 9-action 26.1: Once dried ensure no clumps of arborio rice wholegrains and or puffed wholegrains by mixing or agitating gently;
step 10-action 27.1: Arborio rice wholegrains and or puffed wholegrains of individual colour can now be added together and is ready for use.

As is illustrated from FIGS. 7 to 15, the invention can be used to produce baked products such as, like a biscuit; a cake; a pancake; a baked confectionery; a bread roll; a muffin; a scone; a cookie; a wrap; a pita bread; unleavened bread such as Lebanese bread. Alternatively, the dough or batter and grain product can be fried to produce a donut; or boiled to produce a bagel type product; or cooked on a griddle to produce a pancake type product.

Regular or traditional wholegrains or puffed wholegrains can be used for this invention. Regular and or traditional wholegrains can be used in bread and or baked good products, and these grains can be activated by soaking to soften them for consumption. Coloured wholegrains that have been activated and added to doughs or batters, can cause the wholegrains to leach colour throughout dough or batter during the kneading process, as the wholegrains are activated following the colouring process. Leaching of colour into dough or batter can cause the dough or batter to change in colour during the kneading process, usually to a subtle brown tone. This colour change may not be preferable for white based doughs or batters but a useful result can still be achieved with wholemeal and or dark bread/dough bases. The effect of the colour leaching can be used in the overall design of the finished product, particularly when single colour wholegrains are used i.e. the leaching of pink wholegrains may result in a slightly pink dough or batter base producing a pink wholegrain bread or baked good products pink in tone.

Puffed wholegrains do not require activation or soaking after the colouring process and do not cause any colour leaching into dough or batter. If the wholegrains are not utilised in a puffed condition, then puffing the wholegrains prior to the colouring process is preferred for best results, particularly when used with white based doughs or batters as the white base enhances the visual effects of the puffed multi-coloured whole grains as mixed throughout the product.

Puffed wholegrains typically fully absorb colour dyes and water mixers resulting in wholegrains that are coloured internally as well as externally which, when the finished product is sliced, reveals internal colour from the wholegrains sliced in the process.

Suitable puffed whole grains include: Millet, Quinoa, Amaranth, Rice, Corn, Wheat, Barley, Spelt, Buckwheat.

The above described embodiments create an appealing multi coloured wholegrain and or puffed wholegrain bread and or cooked goods with excellent nutritional value that children are expected to find fun and enjoyable.

In the above description no specific recipe for the dough that may be used. In this respect, any appropriate dough recipe can be used, and reference can be had to such websites as: https://en.wikibooks.org/wiki/Cookbook:Dough and https://en.wikipedia.org/wiki/Dough can be referred to in order to produce a desired dough to which the coloured grains and or puffed grains can be added.

Reference above is made to the expression: “wholegrains and or puffed wholegrains”. This expression is refers to there being present: only wholegrains; only puffed wholegrains; or a combination of both wholegrains and puffed wholegrains. Reference above is also made to the expression: “grains and or puffed grains”. This expression is refers to there being present: only grains; or only puffed grains; or a combination of both grains and puffed grains.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A method of making a dough or batter-based product with colored grains, said method including the steps of:
soaking puffed wholegrains in one or more dyes to provide coloured puffed wholegrains; and
adding the coloured puffed wholegrains to dough or batter.

2. The method as claimed in claim 1, wherein the puffed wholegrains are dried before being added to the dough or batter.

3. The method as claimed in claim 1, wherein the puffed wholegrains are agitated while drying to prevent the puffed wholegrains from clumping, before being added to the dough or batter.

4. The method as claimed in claim 1, wherein puffed wholegrains of more than one colour are provided, and these are mixed together according to a predetermined mixture proportion, before being added to the dough or batter.

5. (canceled)

6. The method as claimed in claim 1, wherein the dough or batter is made from a flour which when cooked provides a desired contrast or background for the colour or colours of the puffed wholegrains added to the dough or batter.

7. The method as claimed in claim 1, wherein said puffed wholegrains are added to dough and are added thereto by a kneading process.

8. The method as claimed in claim 1, wherein said puffed wholegrains are added to dough which is allowed to proof or prove before cooking.

9. The method as claimed in claim 1, wherein said puffed wholegrains are added to dough that is punched prior to cooking.

10. The method as claimed in claim 1, wherein said product is cooked by baking; frying or boiling or any appropriate cooking process.

11. A dough or batter-based product with colored wholegrains produced by the method of claim 1.

12. A dough or batter-based product with puffed wholegrains which are dyed.

13. (canceled)

14. A baked, boiled or fried food product, produced by baking, frying or boiling the dough or batter-based product as claimed in claim 12.

15. The baked, boiled or fired food product as claimed in claim 14, wherein said baked, boiled or fried food product is one of: a loaf of bread; a biscuit; a cake; a pancake; a baked confectionery; a bread roll; a baguette; a muffin; a scone; a cookie; a donut; a bagel; a wrap; a pita bread; unleavened bread such as Lebanese bread etc.

16. The method as claimed in claim 1, wherein the puffed wholegrains are soaked in dyes of different colours to provide puffed wholegrains of different colours.

17. A baked, boiled or fried food product, produced by baking, frying or boiling the dough or batter-based product as claimed in claim 11.

18. The baked, boiled or fried food product as claimed in claim 15, wherein said baked, boiled or fried food product is one of: a loaf of bread; a biscuit; a cake; a pancake; a baked confectionery; a bread roll; a baguette; a muffin; a scone; a cookie; a donut; a bagel; a wrap; a pita bread; unleavened bread such as Lebanese bread etc.
